(19) United States
(12) Patent Application Publication
(10) Pub. No.: US 2026/0119915 A1
(43) Pub. Date: Apr. 30, 2026

(54) SENTIX-IED - Decision State Intelligence System

(71) Applicant: Jose Reginaldo Valente Junior, Sao Paulo (BR)

(72) Inventor: Jose Reginaldo Valente Junior, Sao Paulo (BR)

(21) Appl. No.: 19/408,895

(22) Filed: Dec. 4, 2025

(30) Foreign Application Priority Data
Nov. 18, 2025 (BR) 1020250252678

(51) Int. Cl. G06N 5/022

(52) U.S. Cl. CPC G06N 5/022

(57) ABSTRACT

A system and method for evaluating and managing human decision readiness are disclosed. The system integrates physiological, cognitive, emotional, and contextual data to generate a decision readiness index associated with a subject Based on this index, the system is configured to detect states of elevated decision risk and to trigger preventive interventions prior to execution of a critical decision. The method includes collecting multimodal input data, processing the data through predefined analytical models, generating a readiness assessment, and providing actionable feedback or restriction mechanisms when predefined thresholds are exceeded. The disclosed architecture is applicable to high-impact decision environments and is designed to reduce error, regret, and adverse outcomes by intervening before irreversible decisions are made.

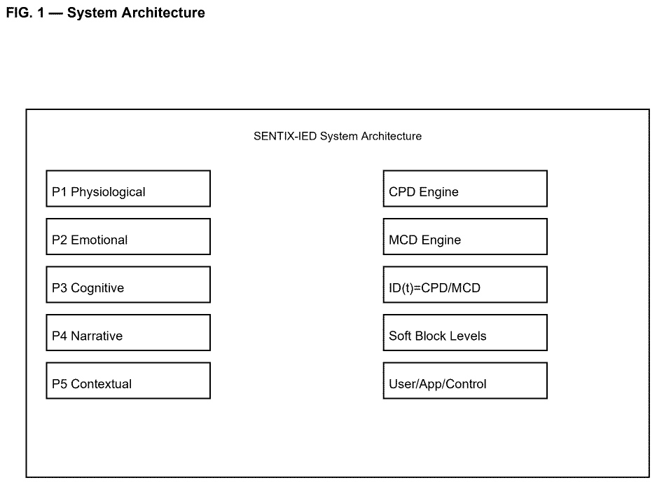

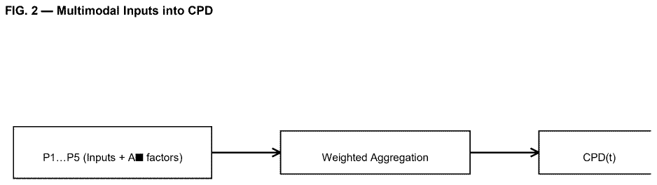

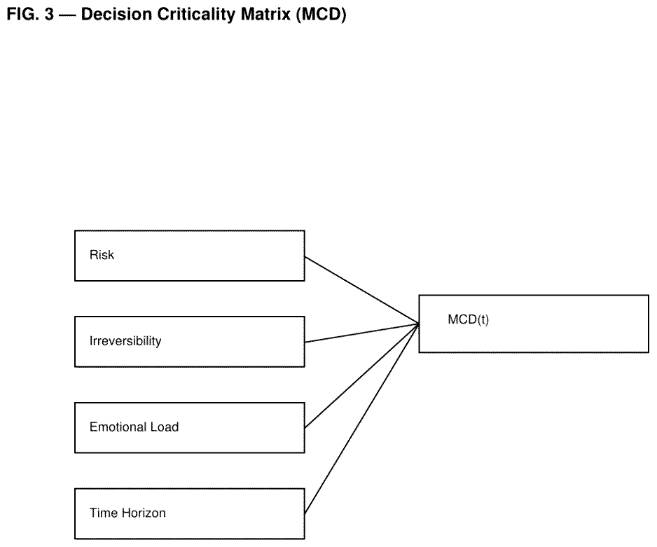

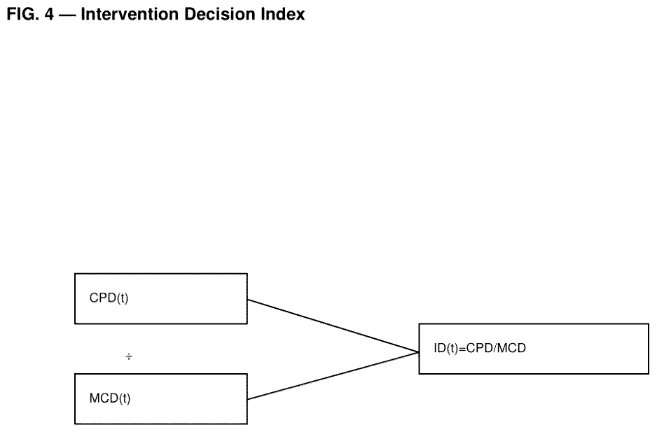

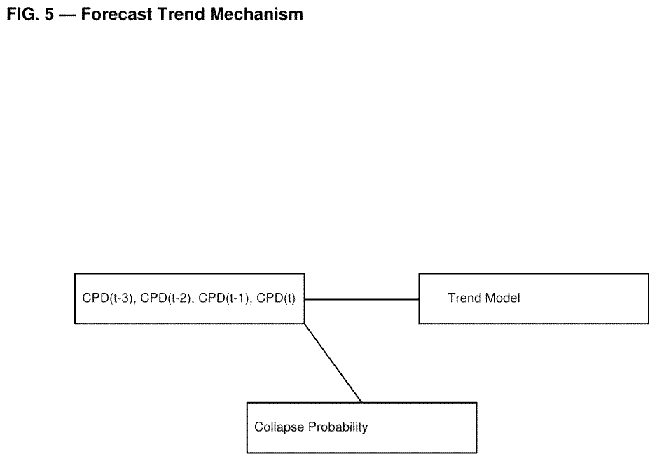

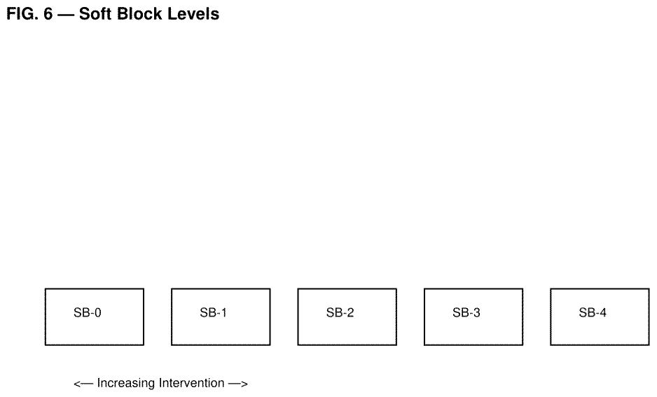

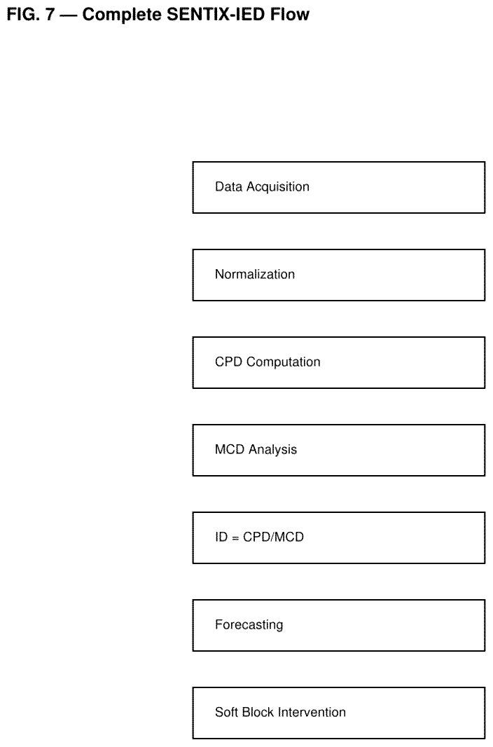

### DETAILED DESCRIPTION OF THE INVENTION

The following detailed description presents the fundamental architecture, computational mechanisms, operational flows, and decision-governance processes of the SENTIX-IED system, an artificial intelligence framework designed to measure, classify, forecast, and intervene upon the human decision state in real time.

The invention integrates multimodal inputs, probabilistic normalization, criticality evaluation, forecasting methods, and adaptive intervention logic to compute a proprietary Intervention Decision Index (ID) and apply graduated Soft Block mechanisms.

This description is illustrative and does not limit the possible embodiments of the invention. Variations in implementation, weighting schemes, sensor types, and interface formats remain fully compatible with the invention's core claims.

### 1. OVERVIEW OF THE SYSTEM ARCHITECTURE

The SENTIX-IED system operates as a layered computational architecture combining: 1. multimodal physiological and behavioral data acquisition; 2. structured narrative and contextual input; 3. a decision-readiness estimation engine (CPD); 4. a decision-criticality evaluation engine (MCD); 5. a composite Intervention Decision Index (ID); 6. a probabilistic forecasting module; 7. adaptive graduated interventions known as Soft Blocks (SB-0 to SB-4).

The architecture is designed for on-device processing and may run on mobile phones, wearable devices, embedded sensors, desktops, or mission-critical systems.

### 2. MULTIMODAL INPUT DOMAINS (P-P)

All incoming data is organized into five principal domains, each producing: ⋅a normalized value P (t) [0, 1] ⋅a confidence weight A (t) [0, 1]

### 2.1 Domain P—Physiological Coherence

Includes HRV, heart rate, respiratory indicators, autonomic markers, sleep proxies, and other physiological readiness indicators. Deviation from baseline reduces P (t).

### 2.2 Domain P—Emotional Coherence

Derived from micro-expressions, vocal features, structured affect reports, or rapid scales. P (t) represents emotional stability.

### 2.3 Domain P—Cognitive Coherence

Obtained via cognitive-load proxies, reaction-time tasks, uncertainty markers, or mental-clarity reports. Lower P (t) indicates overload or impulsivity.

### 2.4 Domain P—Narrative Coherence

Computed from text-based analysis of the intended decision. Semantic stability, clarity, and internal consistency increase P (t); contradictions or fragmentation decrease it.

### 2.5 Domain P—Contextual Coherence

Includes time of day, recent sleep, environmental risk, decision category, and situational modifiers.

If any domain is missing, dynamic renormalization ensures weight consistency: W′=W/>ΣW (only for available domains)

### 3. CONFIDENCE WEIGHTS A (T)

Each domain receives a confidence factor depending on data completeness or noise.

Examples: ⋅A=1.0 for high-quality data ⋅A=0.5 for partial data ⋅A=0.0 for missing or corrupted data

Confidence acts as a gating mechanism preventing unreliable signals from distorting CPD.

### 4. COMPUTATION OF THE DECISION READINESS METRIC (CPD)

CPD is a confidence-adjusted weighted aggregation of the five domains: CPD(t)=Σ[W·A (t)·P(t)]/Σ[W·A (t)]

CPD [0, 1]. Lower CPD indicates impaired readiness.

### 5. THE DECISION CRITICALITY MATRIX (MCD)

MCD evaluates the intrinsic gravity of the decision, independent of the user state. It integrates four components: ⋅R—Risk ⋅I—Irreversibility ⋅E—Emotional Load ⋅T—

### Temporal Horizon

Weighted as:

$$MCD ( t ) = 0.30 R + 0.30 I + 0.2 E + 0.20 T MCD [ 0 , 1 ] .$$

In one specific implementation used in the MVP prototype, the Decision Criticality score MCD (t) is operationalized in a simplified discrete form with three representative levels, such as MCD {1.0, 1.2, 1.5}, corresponding respectively to lower, moderate, and higher criticality. This discrete implementation is a particular parametrization of the continuous formulation defined above and remains fully within the scope of the present invention.

### 6. COMPOSITE INTERVENTION DECISION INDEX (ID)

The SENTIX-IED system computes a unified Intervention Decision Index (ID) by combining the user's decision-readiness state with the criticality of the intended action.

In the present embodiment, fully aligned with the architecture described in claim 3 and with the operational MVP (Version 4), the ID is computed according to the following relationship:

$$ID ( t ) = CPD ( t ) / MCD ( t )$$

Interpretation ⋅ID increases when CPD (t) increases, reflecting higher coherence and decision readiness. ⋅ID decreases when MCD (t) increases, reflecting higher objective criticality or risk. ⋅Lower ID (t) values indicate a dangerous or incoherent decision state, demanding stronger protective interventions. ⋅Higher ID (t) values indicate alignment and readiness, requiring minimal or no intervention.

This formulation replaces prior risk-oriented variants and establishes the readiness-oriented mathematical embodiment adopted in the SENTIX-IED MVP V4.

### 7. FORECASTING MECHANISM

The invention implements a trend-based probabilistic model to anticipate collapse of decision readiness.

Let:

$$Δ CPD ( t ) = CPD ( t ) - mean [ CPD ( t - 1 ) , CPD ( t - 2 ) , CPD ( t - 3 ) ]$$

A collapse probability is computed as:

$$p\_collapse ( t ) = 0.6 \times ( 1 - CPD ( t ) ) + 0.4 \times max ( 0 , - Δ CPD ( t ) )$$

If p_collapse>0.50, the system escalates the Soft Block level proactively.

### 8. SOFT BLOCK INTERVENTION LEVELS (SB-0 TO SB-4)

Mapping used in the MVP and protected in claim 5: ⋅SB-0: ID 0.70 ⋅SB-1:

$$0.4 ID < 0.7 \cdot SB - 2 : 0.2 ID < 0.4 \cdot SB - 3 / 4 : ID < 0.2$$

Soft Block intensity increases as ID decreases.

Note on Numerical Scale (0-1 vs 0-100). The Intervention Decision Index ID (t) described in this specification is expressed in normalized form on a 0-1 scale. In the practical MVP implementation, ID (t) is expressed on a 0-100 scale by multiplying the normalized value by 100. The Soft Block thresholds in the MVP (SB-0: ID 70; SB-1:40 ID<70; SB-2/SB-3: ID<40) are mathematically equivalent to the normalized thresholds described above (0.70,0.40, 0.20). This numerical transformation does not alter the underlying logic of the invention, and both representations fall within the scope of the present specification. Users may override interventions, and all override events are logged.

9. Operational Flow 1. User initiates or describes an intended decision 2. System acquires P—Pinputs 3. Confidence A (t) applied 4. CPD (t) computed 5. MCD questionnaire completed 6. ID (t)=CPD/MCD computed 7. Forecast evaluated 8. Soft Block level selected 9. Intervention applied 10. Full audit log generated

### 11. EMBODIMENTS

Compatible with: ⋅mobile and wearable systems ⋅desktop and enterprise environments ⋅defense, aviation, and mission-critical operations ⋅healthcare and cognitive-monitoring contexts

### 12. VARIATIONS AND EXTENSIONS

The system supports extensions such as: ⋅alternative weighting schemes⋅learning-based dynamic weight adaptation ⋅expanded sensor fusion ⋅longitudinal decision-profile modeling

All remain consistent with the core CPD-MCD-ID-Forecast-Soft Block framework.

What is claimed is:

1. A computer-implemented system for assessing human decision readiness and generating graduated protective interventions, comprising:
(1) a multimodal measurement module configured to obtain physiological, emotional, cognitive, narrative, and contextual signals from a user;
(2) a normalization engine configured to convert each signal into a normalized value P_i(t) within a defined scale and associate each P_i(t) with a confidence factor A_i(t);
(3) a coherence computation module configured to calculate a Decision Readiness Coherence score CPD (t) using weighted aggregation of normalized and confidence-adjusted signals;
(4) a criticality computation module configured to calculate a Decision Criticality score MCD (t) based on at least four weighted components corresponding to risk, irreversibility, emotional load, and temporal impact;
(5) an index computation module configured to compute an Intervention Decision Index ID (t) from CPD (t) and MCD (t) using a monotonic function f, wherein ID (t) increases with decision criticality and decreases with decision readiness;
(6) an intervention module configured to trigger one of multiple graduated Soft Block levels based on the value of ID (t); and
(7) a logging module configured to record user state, computed metrics, triggered interventions, override events, and timestamps for auditability and causal verification.

2. First Mathematical Embodiment of the Intervention Decision Index (ID) The system of claim 1, wherein the function f used to compute the Intervention Decision Index ID (t) is implemented according to the relationship:
$$ID ( t ) = MCD ( t ) \backslash times ( 1 - CPD ( t ) )$$
Such that: (a) ID (t) increases when the Decision Criticality score MCD (t) in-creases, reflecting that more critical decisions require stronger protective intervention;
(b) ID (t) increases when the Decision Readiness score CPD (t) decreases, reflect-ing deteriorating coherence or readiness;
(c) higher values of ID (t) correspond to higher predicted risk, and therefore trigger higher Soft Block intensities; and
(d) Soft Block levels are selected based on threshold intervals defined for this risk-oriented embodiment.

3. Alternative Mathematical Embodiment of the Intervention Decision Index (ID) The system of claim 1, wherein the function f used to compute the Intervention Decision Index ID (t) is alternatively implemented according to the relationship:
$$ID ( t ) = CPD ( t ) / MCD ( t )$$
Such that: (a) the value of ID (t) increases as the Decision Readiness score CPD (t) increases; (b) the value of ID (t) decreases as the Decision Criticality score MCD (t) increases; (c) the resulting ID (t) is mapped to Soft Block levels by predefined readiness thresholds; and (d) this embodiment enables a readiness-oriented interpretation of ID (t) distinct from the risk-oriented embodiment of claim 2.

4. Structure of the Decision Criticality Score (MCD) The system of claim 1, wherein the Decision Criticality score MCD (t) is computed as a weighted sum of four components: risk (R), irreversibility (I), emotional load (E), and temporal impact (T), with respective weights 0.30, 0.30, 0.20, and 0.20.
SB-0 (No Intervention): when ID (t)>=0.70; SB-1 (Low-Intensity Warning): when 0.40<=ID (t)<0.70; SB-2 (Moderate Protective Delay): when 0.20<=ID (t)<0.40; SB-3 or SB-4 (High-Intensity Protective Hold): when ID (t)<0.20.
0.40·SB-3 or SB-4 (High-Intensity Protective Hold): when ID (t)<0.20
Wherein: (a) the Soft Block intensity increases as ID (t) decreases; (b) ID (t) is computed according to the mathematical relationship ID (t)=CPD (t)/MCD (t); and (c) each Soft Block level corresponds to a predefined protective action stored in the intervention policy.

6. Forecast Module The system of claim 1, further comprising a predictive module configured to compute a collapse probability p_collapse (t) using:
p_collapse (t)=0.60×(1−CPD(t))+0.40×max (0, −ACPD(t)), and to increase the Soft Block level when p_collapse (t) exceeds 0.50.

7. Audit Logging The system of claim 1, wherein the logging module stores a machine-readable record containing:
(a) all P_i(t) values; (b) all confidence factors A_i(t); (c) CPD (t), MCD (t), and ID (t); (d) the Soft Block level triggered; (e) any user override actions; and
(f) timestamps corresponding to each recorded event.

8. Ethical Override Mechanism The system of claim 1, wherein the user may override triggered interventions, and each override event is logged together with preceding CPD, MCD, and ID values.

9. On-Device Execution The system of claim 1, wherein all computational steps are executed locally on a mobile device, wearable device, or both, without reliance on external servers.

10. Multi-Platform Deployment The system of claim 1, wherein the architecture is deployable across mobile devices, wearable devices, desktop systems, and industrial operational environments without altering the core CPD-MCD-ID computational framework.
